(19) United States
(12) Patent Application Publication
(10) Pub. No.: US 2008/0287141 A1
(43) Pub. Date: Nov. 20, 2008

(54) Method and Device for Optimizing the Radio Transmission of Data Between a Vehicle and an External Remote Station

(76) Inventors: Peter Vogel, Hildesheim (DE); Florian Wildschuette, Hildesheim (DE)

Correspondence Address: KENYON & KENYON LLP, ONE BROADWAY, NEW YORK, NY, 10004, US

(21) Appl. No.: 11/791,106

(22) PCT Filed: Oct. 19, 2005
(86) PCT No.: PCT/EP05/55380

§ 371 Date: Jul. 24, 2008

(30) Foreign Application Priority Data
Nov. 17, 2004 (DE) 10 2004 055 275.4

(51) Int. Cl. H04Q 7/20

(52) U.S. Cl. 455/456.3

(57) ABSTRACT

Control of the transmission of data between a vehicle and an external remote station that functions as a data source or data sink is geographically and temporally planned in order to achieve an optimization of the data transmission. In the planning of the data transmission, information is taken into account that is determined by the driver information system of the vehicle, as well as information (e.g., as radiotelephone network information) concerning the radiotelephone networks that are available for the data transmission.

### FIELD OF THE INVENTION

The present invention relates to a method and a system for optimizing the radio transmission of data between a vehicle and an external remote station that functions as a data source and/or data sink, in particular for optimizing data transmission between a vehicle and an external data server, the vehicle being equipped with a driver information system.

### BACKGROUND INFORMATION

Access to the Internet is now also possible in mobile fashion, due to the development of mobile radiotelephone standards such as GPRS and UMTS, and due to the available mobile radiotelephone infrastructure. The special character of mobile radiotelephone networks permits constant online access (“always-on”), in which only the transmitted data quantity, but not the connection time, is accounted.

In addition, data can also be transmitted to a motor vehicle via short-range radio methods (e.g., WLAN). The range is typically up to 300 meters, and the operation takes place as a spot solution with “favorable” conditions for data transport.

As a result, data transfer between vehicles and the Internet is becoming increasingly important, not least because new applications for mobile data transmission are available that enable mobile terminal devices to be connected to the Internet. Thus, e-mails and multimedia messages (MMS) can now be retrieved and sent from a vehicle, or greater quantities of data can be sent and received. Because of this, aspects such as software download and remote diagnosis via the Internet are increasingly becoming a focus of the automobile industry.

Here, the special case of a specific data request via digital radio (DAB) should also be mentioned. Because here the data are sent in broadcast operation, an upstream channel to the broadcast provider is available in order to request them.

In practice, different demands are placed on the radio connection between a vehicle and the Internet depending on the characteristics of the data to be transmitted. Thus, in some applications a transmission rate that is as high as possible will be emphasized, while in other cases the reliability of the connection is to be prioritized.

Moreover, there are a large number of mobile radiotelephone network operators that offer the transmission of data with widely varying conditions and costs; e.g., home zone rates, favored rates for particular countries, etc. The user is also subject to different costs due to the use of different technologies, such as UMTS, GPRS, GSM, WLAN, Bluetooth, DAB, etc., each of which is based on different fee structures and fixed costs.

Because, generally, the user of a vehicle does not know which radiotelephone network infrastructure is available to him/her at what time along a particular travel route, or what costs are connected with a data transmission using this radiotelephone network infrastructure, an optimization of the data transmission along a travel route is difficult in practice.

### SUMMARY

According to the present invention, the data transmission between a vehicle and an external remote station is geographically and temporally planned in order to achieve an optimization of the data transmission along the travel route of the vehicle.

According to an example embodiment of the present invention, in the planning of the data transmission, information is taken into account that is determined by the driver information system of the vehicle, as well as information concerning the radiotelephone networks available for the data transmission, known as radiotelephone network information.

An example embodiment of the present invention takes advantage of the fact that many vehicles are already equipped with a driver information system having integrated navigation capability, so that navigation information, such as, for example, the planned route of travel, the current vehicle position, the destination, specific information concerning particular coordinates, or address lists, are available. In addition, a driver information system can supply vehicle information, such as, for example, the current speed of the vehicle or a speed profile over a particular period of time, as well as user information, such as standing or pause times, particular business appointments, individual user profiles, e.g., concerning habitual behavior, general pause behavior, general speed profiles, etc. This information can be used to optimize the data transmission to and from a vehicle during the trip, i.e., along a travel route. According to an example embodiment of the present invention, this information is combined with radiotelephone network information in order to select, on the basis of the various radiotelephone network systems that are available to the vehicle along its travel route, the radiotelephone connection that is most suitable for the data transfer in question. In addition to a suitable radiotelephone network system, or favorable network operators, on the basis of information such as the current vehicle position and speed it is also possible automatically to determine or select suitable times and data quantities for the upcoming data transfer. In making this selection, various aspects of the data transmission can be prioritized. Optimization criteria can be for example a transmission rate that is as high as possible, a radio connection that is as stable as possible, a fulfillment of a defined “quality of service” (QoS) that is as high as possible, a number of network providers along the route traveled that is as low as possible, a delay that is as small as possible in the provision of the information, and/or costs that are as low as possible for the data transfer. Here it is to be noted that the data transmission along a travel route can also be planned and controlled in accordance with a combination of a plurality of optimization criteria.

As a rule, the radiotelephone network information includes information concerning the radiotelephone network infrastructure. However, available radiotelephone network information can also include information concerning local subscriber density and/or additional information concerning the mobile radiotelephone operators, such as, e.g., information concerning transmission rates, costs, and other conditions.

In an advantageous embodiment of the method according to the present invention, in addition to the information determined by the driver information system and the radiotelephone network information, vehicle equipment information can also be taken into account in the planning and controlling of the data transmission, such as information concerning the vehicle type and concerning the equipping of the vehicle with transmit and receive equipment. In this way, for example the particular situation of an ambulance can be taken into account, or also the situation in a travel bus having a plurality of passengers who want to perform an individual data transfer during a trip.

In another advantageou's embodiment of the method according to the present invention; environmental information can also be taken into account in the planning and controlling of the data transmission, such as information concerning the current traffic situation and the current weather conditions.

All the information that is taken into account in the planning and controlling of the data transmission along a travel route, in particular the navigation information, the user information, the radiotelephone network information, the vehicle equipment information, and/or the environmental information, can be maintained centrally by an external server and retrieved from this server. In this case, the planning and/or controlling of the data transmission can be carried out by an external data processing unit that communicates with the driver information system. In addition, or alternatively, the information that is taken into account in the planning and controlling of the data transmission can also be present locally in the vehicle. In this case, the planning and controlling can also be carried out by a vehicle-internal logic module, for example by the driver information system.

As already mentioned, the demands placed on a data transfer between a vehicle and an external remote station depend on the type of data, and finally on the application on which the data transfer is based. Correspondingly, there are various possibilities for realizing and designing the method according to the present invention.

In an advantageous embodiment of the method according to the present invention, first the desired travel route is determined. The data transmission is then planned on the basis of this travel route, or on the basis of the corresponding navigation information determined by the driver information system, and on the basis of the radiotelephone network information available for this travel route. This embodiment may be advantageous, for example, if large quantities of data are to be loaded, and the upload is to take place in the background at an arbitrary point in time, such as, e.g., for the execution of automatic software updates. In these cases, on the basis of the travel route and the vehicle speed the path segments having a suitable network coverage can be determined, and favorable times for the data transmission can also be determined.

In another advantageous embodiment of the method according to the present invention, the radiotelephone network information is already taken into account in determining the travel route, in order to optimize the data transmission in accordance with a predeterminable optimization criterion. In this embodiment, the user specifies an optimization criterion, or also a plurality of optimization criteria, for the data transmission, which is/are then taken into account together with the radiotelephone network information in the planning of the travel route. In this way, it can be ensured that for the transmission of important data, for example patient data during ambulance transport, a connection having a predetermined level of quality is available at all times. The determination of the travel route dependent on the available radiotelephone network infrastructure can however also make sense if long downloads are to be carried out.

In this embodiment of the method according to the present invention, when determining the travel route, it is often advantageous to take into account, besides the radiotelephone network information, route criteria, user information, vehicle equipment information, and/or environmental information. Such a route criterion can for example be that the travel route may deviate only by a maximum predetermined distance or predetermined driving time from the shortest or fastest travel route between the departure location and the destination. In this case, it is also possible to take into account the current traffic situation. The type of vehicle can likewise play a role in route planning, for example, in the case of an ambulance, which is also permitted to travel the wrong way on one-way streets.

The planning of the travel route can be carried out by the driver information system, or also by an external data processing unit that communicates with the driver information system.

### BRIEF DESCRIPTION OF THE DRAWINGS

FIG. 1 shows the flow diagram of an example method according to the present invention for optimizing the radio transmission of data between a vehicle and an external server.

FIG. 2 shows the individual components of a system according to an example embodiment of the present invention for optimizing the radio transmission of data between a vehicle and an external server.

FIG. 3 shows a map segment that also portrays the radiotelephone network infrastructure of the region shown.

### DETAILED DESCRIPTION OF EXAMPLE EMBODIMENTS

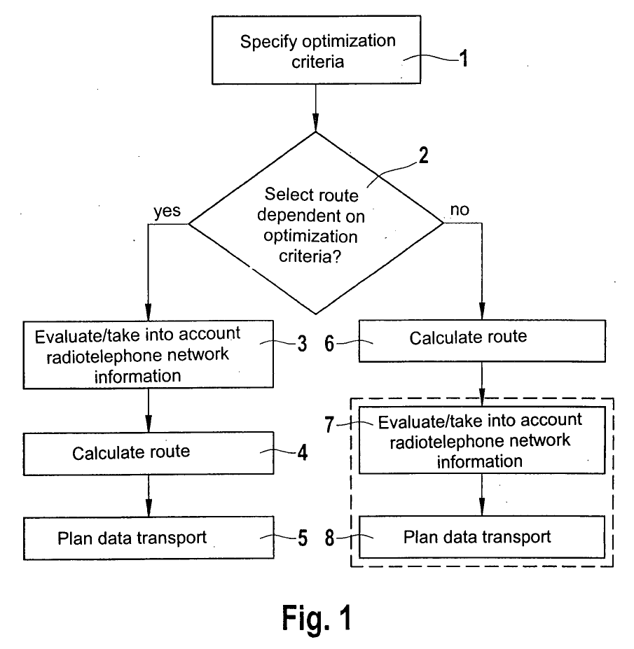

In the embodiment shown in FIG. 1 of a method according to the present invention, in a first step 1 the user specifies an optimization criterion, or a plurality of such criteria, for the upcoming data transfer. Depending on the design of the interface between the user and the system for executing the method, this can for example take place with the aid of a menu that is automatically displayed when the system is activated and that provides the user with a selection of various optimization criteria. The selection can then take place, e.g., via a keyboard or a touch screen, or by speech input.

In a second step 2, it is queried whether the travel route of the vehicle should be determined dependent on this at least one optimization criterion for the data transmission, or independent thereof.

If the optimization criterion is to be taken account in determining the travel route, radiotelephone network information is supplied to the driver information system or to the navigation system of the vehicle in step 3 before the route is calculated. This radiotelephone network information can either be stored on a vehicle-internal storage unit or can also be retrieved from a central external server, for example from the Internet. In step 4, a travel route is then calculated, during which the navigation system takes into account, besides the location- and path-related input parameters for the navigation, the radiotelephone network information and the optimization criterion for the data transfer. Here, it is to be noted that in the calculation of the travel route, route criteria, environmental information, user information, and/or vehicle equipment information can also be taken into account, which however is not shown in detail in FIG. 1. Subsequently, in step 5 the local and temporal planning of the data transfer takes place, based on the navigation information of the determined travel route, the corresponding radiotelephone network information, and the specified optimization criterion. In the planning of the data transfer as well, vehicle information, user information, vehicle equipment information, and/or environmental information can also be taken into account. The data transfer can then also be executed at least partly automatically during the trip, on the basis of this planning.

If the optimization criterion is not to be taken into account in the selection of the travel route, a travel route is first determined, in step 6. If this determination takes place with the aid of the navigation system, only the standard local and path-related input parameters are taken into account. Independent of the route determination, in step 7 radiotelephone network information is retrieved. This information is used as a basis for the local and temporal planning of the data transfer in step 8, together with the navigation information relating to the travel route and the optimization criterion.

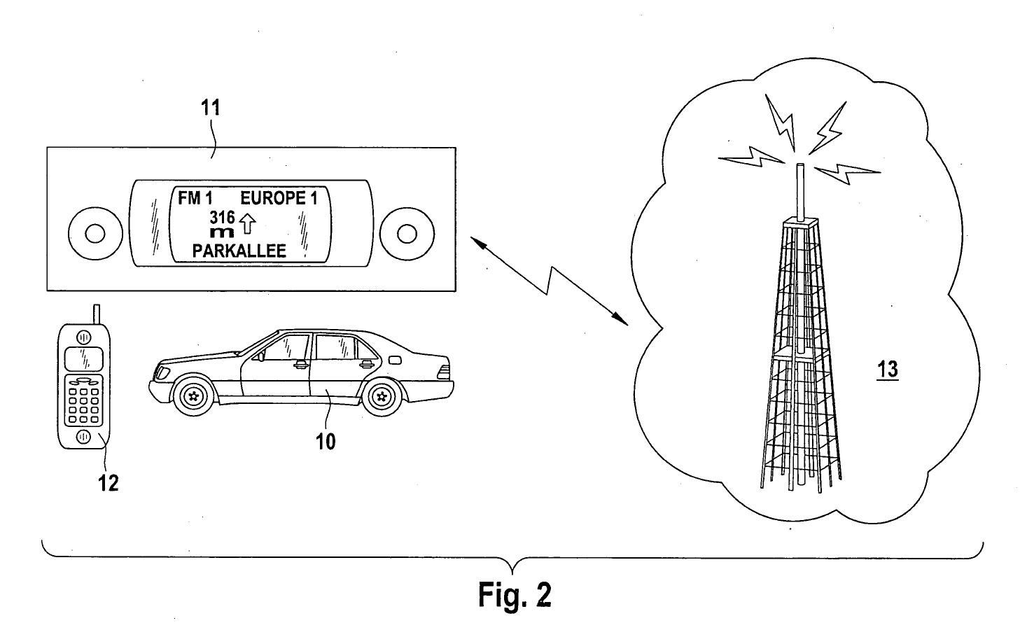

As was already indicated for the example of the interface between the user and the system, the individual functions of the system according to the present invention for optimizing the radio transmission of data between a vehicle and an external remote station can be realized by different components, as is explained in more detail on the basis of FIG. 2. In any case, vehicle 10 should have an available driver information system 11, which supplies the navigation information used for planning the data transfer. Moreover, in vehicle 10 there should be a radio module 12 for the realization of a radio connection to an external remote station, e.g., a data server. Navigation devices having an integrated mobile radiotelephone module are available that can be effectively used for the realization of the system discussed here. In addition, an arrangement is used for providing and updating radiotelephone network information. In the exemplary embodiment shown in FIG. 2, this is an external server 13 from which current radiotelephone network information can always be retrieved. Additionally, or alternatively, a corresponding database can also be stored locally in the vehicle, e.g., on a hard disk or a CD. Finally, in vehicle 10 there should be a logic module for the organization of the data transmission. This logic module is not shown in detail here, because it can for example be integrated into driver information system 11 or into radio module 12. However, the functions of the logic module can also be taken over by other mobile terminal devices, such as for example PDAs, if these are equipped with the required infrastructure, such as computing power, storage capacity, ports, displays, and communication modules based on GSM, GPRS, Bluetooth, etc.

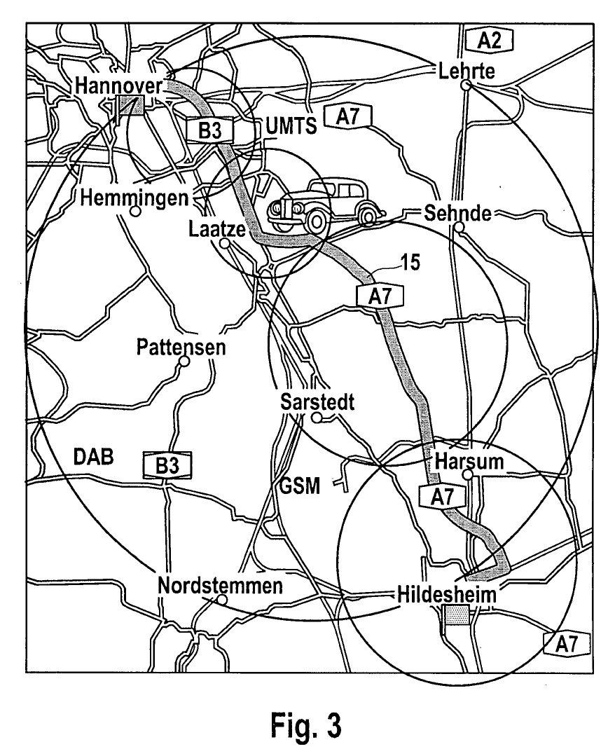

An example of an application of the method according to the present invention for optimizing the radio transmission of data between a vehicle and an external server is explained in the following on the basis of the map segment shown in FIG. 3, in which a travel route 15 from Hildesheim to Hannover is shown, as well as the spatial coverage of this travel route 15 by various mobile radiotelephone systems, i.e., GSM and UMTS, and by digital broadcast radio DAB.

The user of a vehicle 10 wishes to travel from Hildesheim to Hannover. During the trip, he wants to make some telephone calls and send and receive e-mails. Moreover, during the trip he is planning to find information about current museum exhibitions in Hannover. This information is broadcast via DAB. Moreover, the vehicle manufacturer has indicated in the display that a large software packet for optimizing vehicle functions is available for download.

In the example application described here, the user first calculates a travel route 15, entering “Hannover” as destination into the navigation system of vehicle 10. The resulting navigation information is communicated to an external server or to a control unit present in the vehicle. There, information is present concerning the radiotelephone network infrastructure, so that the server or control unit can determine the radiotelephone connections that are available along travel route 15. This information is communicated to a logic module in the vehicle that plans and controls the data transfer desired by the user, so that at least a part of the data transfer, here the sending and receiving of e-mails, can also be executed automatically. The data to be transmitted is divided into small packets that are sent independent of one another and assembled again at the receiver. Radio methods, times, providers, content and data division can be automatically selected dependent on vehicle speed, time, and/or data profile.

In the example application described here, the user has the possibility of telephoning along the entire route using either a GSM connection or a UMTS connection. It is recommended to receive and send e-mails in the urban area of Hannover, because there a fast UMTS connection can be used. As soon as the vehicle has reached Harsum, the desired information concerning the exhibitions in the Hannover museums can be received, because vehicle 10 is then located within the range of DAB coverage. Because as the travel destination a street in the vicinity of a shop of the manufacturer has been indicated, the transmission of the software packet takes place via the local WLAN radio service of the shop.

1-15. (canceled)

16. A method for optimizing radio transmission of data between a vehicle and an external remote station that functions as at least one of a data source and a data sink, for optimizing the data transmission between the vehicle and an external data server, the vehicle being equipped with a driver information system, the method comprising:
geographically and temporally planning and controlling the data transmission; and determining information with the aid of the driver information system, the determined information and radiotelephone network information being taken into account in the planning and controlling.

17. The method as recited in claim 16, wherein the information determined by the driver information system includes at least one of: i) navigation information including at least one of a planned travel route, a current vehicle position, a destination, specific information concerning particular coordinates, and address lists, ii) vehicle information including at least one of a current speed and a speed profile over a particular period of time, and iii) user information including at least one of a specific pause time, a specific business appointment, and an individual user profile.

18. The method as recited in claim 17, wherein the information determined by the driver information system includes the individual user profile, the individual user profile including information regarding driver habits, pause behavior and speed profile.

19. The method as recited in claim 16, wherein the radiotelephone network information includes at least one of an infrastructure of a radiotelephone network, a local subscriber density, a transmission rate, and costs and conditions of the transmission.

20. The method as recited in claim 16, wherein in the planning and controlling of the data transmission, vehicle equipment information is taken into account, the vehicle equipment information including information concerning a type of vehicle, and information concerning the devices in the vehicle for radio transmission.

21. The method as recited in one of claim 16, wherein in the planning and controlling of the data transmission, environmental information is taken into account, the environmental information including at least one of a current traffic situation, and information concerning current weather conditions.

22. The method as recited in claim 16, wherein at least one of navigation information, user information, radiotelephone network information, vehicle equipment information, and environmental information are retrieved from a data source outside the vehicle from an external server.

23. The method as recited in claim 16, wherein at least one of the planning and controlling of the data transmission is carried out by an external data processing unit that communicates with the driver information system.

24. The method as recited in claim 16 wherein at least one of the information determined by the driver information system, the radiotelephone network information, vehicle equipment information, and environmental information are stored locally in the vehicle.

25. The method as recited in claim 16, wherein at least one of the planning and controlling of the data transmission is carried out by a vehicle-internal logic module of the driver information system.

26. The method as recited in claim 16, further comprising:
determining a travel route, the data transmission being planned based on navigation information relating to the travel route and the radiotelephone network information available for the travel route.

27. The method as recited in one of claim 26, wherein at least one optimization criterion for the data transmission is taken into account during the determining of the travel route.

28. The method as recited in claim 27, wherein route criteria, are taken into account in the planning of the travel route, the rate criteria including maximum value, the deviation from one of a fastest rate and a shortest rate.

29. The method as recited in claim 26, wherein at least one of user information, vehicle equipment information, and environmental information is taken into account in the determining of the travel route.

30. The method as recited in claim 26, wherein the determining of the travel route is carried out by an external data processing unit that communicates with the driver information system.

31. A system for optimizing the radio transmission of data between a vehicle and an external remote station that functions as at least one of a data source and a data sink, the system comprising:
a driver information module in the vehicle that supplies at least navigation information;
a mobile radiotelephone module in the vehicle;
an arrangement adapted to provide and update radiotelephone network information; and
a logic module adapted to plan and control the data transmission taking into account information of the driver information module and radiotelephone network information.
